(19) United States
(12) Patent Application Publication
(10) Pub. No.: US 2014/0222793 A1
(43) Pub. Date: Aug. 7, 2014

(54) System and Method for Automatically Importing, Refreshing, Maintaining, and Merging Contact Sets

(71) Applicant: Parlance Corporation, Woburn, MA (US)

(72) Inventors: William Sadkin, Belmont, MA (US); Anindya Tapaswi, Natick, MA (US); Larissa Smelkov, Lexington, MA (US); Bruce Musicus, Lexington, MA (US)

(73) Assignee: Parlance Corporation, Woburn, MA (US)

(21) Appl. No.: 14/174,348

(22) Filed: Feb. 6, 2014

Related U.S. Application Data
(60) Provisional application No. 61/761,934, filed on Feb. 7, 2013.

(51) Int. Cl. G06F 17/30

(52) U.S. Cl. CPC G06F 17/3053
USPC 707/723

(57) ABSTRACT

Systems and methods for automatically importing, refreshing and maintaining corrections to a list of contacts through addition, deletion, and change detection, and for merging disparate sources of data into a single unified list of contacts, according to configurable rule sets for resolving conflicts between the merged sources' values for any given field. Record sets are compared and automatically matched without requiring a unique contact identifier or key field; new records and deleted records are detected; conflicting information for any given field in a record is resolved; and updates to a local database are applied such that any override or augmentation of the data in the local database can persist for a given record. Multiple overlapping contact data sources are merged so as to identify common records, and the data combined so as to preserve as much information as possible, while concurrently handling conflicting data as it is encountered.

### CROSS-REFERENCE TO RELATED APPLICATIONS

This application claims benefit under 35 U.S.C. §119 of U.S. Provisional Application Ser. No. 61/761,934, filed Feb. 7, 2013, the contents of which are hereby incorporated by reference.

### BACKGROUND OF THE INVENTION

1. Field of the Invention

The present disclosure relates to systems and methods for contact management, and specifically, for automatically importing, refreshing, and maintaining corrections to a list of contacts, and for merging disparate sources of contact data into a single unified list of contacts.

2. Description of the Background

There are many applications in which a comprehensive, accurate, and unified set of contact data for a large set of entities is essential. However, there are many practical challenges to creating and maintaining such a large set of contact data.

Contact data often exists in multiple primary sources, and each primary source may use a different management system. For example, one primary source may be a spreadsheet, another may be a network directory service, and yet another may be a Private Branch eXchange (PBX) directory.

These primary contact sources are often incomplete or inaccurate; data may be entered incorrectly, inconsistently, or not at all. Further, the information for a given contact may be scattered across primary sources, or may be replicated in multiple primary sources, often with partial or conflicting data in each primary source. Each of these contact sources may have data that is specific to that source's needs, and may be updated independently of each other, causing one or more of the sources to accumulate stale data over time. In addition, the ability and/or permission required to change these primary contact sources may not be easily obtained.

Many existing contact management systems assume that at least one unique identifier or key field, such as a last name, Employee ID, or Social Security Number, exists for each contact record in a data source. These existing systems rely on being able to make an exact match on one or more key fields within two contact records in order to declare that the two records refer to the same entity. While computationally tractable, many primary sources of contact data have no such unique identifier or key field, and these existing systems may not function properly when such exact correlation is not possible (such as when the key field is not populated with data) or when an attempt at correlation provides even more ambiguous matches (such as when the data is entered incorrectly). Further, even if a particular primary contact source has a unique identifier, that same identifier is rarely a shared, global identifier, available across multiple primary sources.

In addition, many existing contact management systems may lose information during a merge, and require manual intervention so as not to drop the original data. For large-scale contact list management, however, such a manual solution is impractical.

It is desirable to be able to combine these disparate primary sources into a common, local database, and then be able to correct and augment that local database as necessary. The augmentation data must also be correlated to the original set of data, even as the original set of data from the primary sources change.

It is also desirable to be able to refresh a local database of contacts with updates from a primary source without losing those local corrections and augmentations (also termed local overrides), so long as the underlying data from the primary source has not changed. In addition, even with the ability to gather information from multiple primary sources, it is often desirable to add contacts not present in any of the available primary sources to the local database, and then easily remove these locally added contacts once those contacts are eventually added to the primary source.

There is a need in the art, then, for an improved system and method for automatically maintaining and merging contact sets. Such an improved system would ideally perform a variety of functions, including but not limited to the following:

(i) comparing two sets of contact records (either old and new, or subsets from disparate primary sources), and automatically matching up the sets of contact records without requiring a unique contact identifier or key field to perform the correlation;

(ii) detecting new contact records and dropped or deleted contact records;

(iii) resolving conflicting information for any given field in a contact record;

(iv) applying updates to a local database of contact records such that any correction or augmentation of the data in the local database can persist for a given contact record as appropriate;

(v) merging multiple overlapping primary sources of contact data, so as to identify common records in those primary sources, and combining the data in those primary sources so as to preserve as much information as possible, while concurrently handling conflicting data as it is encountered; and

(vi) storing locally added contact records to a local database of contacts, and then automatically reconciling those locally added contact records with contacts records presented from a primary source, thereby removing the need to manually remove them from the local database, to avoid duplication, once a matching record is added to that primary source.

These contact sets are often quite large, involving thousands of records, and it is impractical to require a human to manually perform these functions, and so an automatic method for maintaining and merging contact sets is desired. Consider, for example, the task of finding matching records for a large corporate database, where the first data source has fifty thousand contact records, and the second data source has fifty-two thousand contact records. Theoretically, there would be two hundred and sixty billion possible contact record pairs to consider in the matching process, which would impossible for a human to complete manually. In addition, as the number of correlating fields increases, so does the complexity of computing and evaluating the associated match probabilities, such that a human could not possibly manage the task, even if the number of records was significantly reduced. The invention described herein, together with the use of computer processors and database technology, makes the matching problems tractable, and the solutions feasible.

### SUMMARY OF THE INVENTION

The present invention provides systems and methods for automatically importing, refreshing and maintaining corrections to a list of contacts through addition, deletion, and change detection, and for merging disparate sources of data into a single unified list of contacts, according to configurable rule sets for resolving conflicts between the merged sources' values for any given field.

Specifically, in preferred embodiments, the present invention provides systems and methods for contact management that use a semantic content map or schema to translate each field in an input feed of contact records from a primary source into a set of semantic fields. A system of match ranking is used, where the match ranking relies on a set of correlation weights or probabilities that are calculated for particular semantic fields within the records of the contact list. These correlation weights model the likelihood that two contact records match, given a match of values in a particular field in each of the two contact records.

In preferred embodiments, the systems and methods described herein also define a configurable set of fields that constitute evidence of a match, and a set of statistical contributions or probabilities of a likelihood that two contact records match given a match in that particular contact record field. These probabilities are multiplicative, such that the set of possible matches can be ranked based on the total accumulated evidence for each considered match. These field correlation weights may be generated from the data in question and/or combined with measured discrimination data from external sources to generate a better set of rules for declaring a match.

Given this method of computing the match likelihood of a given pair of contacts, the naïve solution of computing each possible record pair's probability of a match is O(n²), which is impractical on large sets of records. (As is known in the art, O(N) notation is used to express the worst-case order of growth of an algorithm. O(n²) notation indicates that the algorithm's performance is proportional to the square of the data set size, which occurs when the algorithm processes each element of a set.) This is made even worse if matches between heterogeneous fields are considered, for example matching a home phone in one source with a cell phone field another source. However, by using a configurable, ordered set of database queries, the systems and methods described herein are intended to reduce the run time required for a search to a practical level.

In preferred embodiments, the invention provides systems and methods for refreshing a contact list by importing new information for a given source of contacts over the previous data stored. Matched records are then processed to update the previous existing information with new information, removing any overrides for field data which has now changed, and replacing augmented data with newly imported data for a given previously-missing semantic field.

A conceptual block diagram of a Contact List Refresh 100 is shown in FIG. 1. A New Version of a Contact List 105, containing new information, may be imported over a previously stored, Existing Version of a Contact List 110. As shown in FIG. 1, the Existing Version of a Contact List 110 may already be associated with augmentation data, in the form of Local Override List 135. Contact List Refresh 100 performs a matching process, as described in detail below, to identify new contacts for adding 115, existing contacts for altering 120, and dropped contacts for removal 125. This augmentation data, together with the locally added data 130, may be used to update the Local Overrides List 135.

In additional preferred embodiments, the invention provides systems and methods for merging multiple sources of incomplete contact information in order to produce a combined single “best of” merged source. The new merged source can be used as an input source for refreshing a contact list (for example, as Contact List 110 in FIG. 1), as described above, such that local overrides may still be performed on the merged source. The merge is non-destructive; that is, the original imported data is preserved for reference, and the merged data is stored as a new source within the contact database.

The same matching algorithm described above may be used to merge multiple sources of contacts to form a new source. When a subset of records across the set of sources is identified as referring to the same entity (for example, a person, group, organization or equivalent), field conflicts are resolved according to a set of precedence rules. The precedence rules define a field precedence order for the source lists involved in the merge, and thus allow for the most authoritative sources for given information to be utilized to define the “best of” nature of the merged set of contacts.

A conceptual block diagram of a Contact List Merge 200 is shown in FIG. 2. Multiple sources of contacts, for example, Contact List A, an Excel® spreadsheet 205, Contact List B, a contact repository in Active Directory® 210, and Contact List C, a PBX directory 215, may be used to form a new Merged Source D 230 by a process of de-duplication 220. De-duplication identifies the same contact among all the sources, Contact Lists A, B, and C, and merges the records to create the new Merged Source D 230 with the contributions from all the participating sources. A representative Contribution Chart is shown as Venn diagram 225.

In a preferred embodiment, the invention provides a method of correlating a first set of contact records having a first set of fields with a second set of contact records having a second set of fields, where the method comprises the steps of: (i) identifying up to N pairs of semantically-identical fields, where one member of each pair is selected from the first set of contact record fields and the other member of each pair is selected from the second set of contact record fields; (ii) associating at least one of the semantically-identical fields with a correlation weight, where the correlation weight represents the non-uniqueness of any given value in that field; (iii) determining if there are fewer than N pairs of semantically-identical fields; (iv) if there are fewer than N pairs of semantically-identical fields, identifying zero, one or more pairs of semantically-similar fields, where one member of each pair is selected from the first set of contact records and the other member of each pair is selected from the second set of contact records, such that the sum of the pairs of semantically-identical fields and the pairs of semantically-similar fields is less than or equal to N; (v) associating at least one of the semantically-similar fields, if any, with a correlation weight, where the correlation weight represents the non-uniqueness of any given value in that field; (vi) identifying up to 2^{N} possible combinations of semantically-identical fields and semantically-similar fields, if any; (vii) associating at least one of the possible combinations with a confidence score, where the confidence score is based on the correlation weights of the semantically-identical fields and the semantically-similar fields, if any, in that combination; (viii) identifying one or more matching rules, where each matching rule is one of the possible combinations of semantically-identical fields and semantically-similar fields, if any, and where the confidence score of each of the matching rules represents an acceptable level of non-uniqueness of any given set of values in that combination of semantically-identical fields and semantically-similar fields, if any; and (ix) applying one or more of the matching rules to identify a set of correlated contact records, where each matching rule is applied by selecting pairs of contact records from the first and second sets of contact records where the values match on all of the semantically-identical fields and semantically-similar fields, if any, in that matching rule.

In an aspect, at least one of the correlation weights is based on a statistical analysis of values in at least one of the contact record fields. In another aspect, the confidence score for at least one of the combinations is based on the product of the correlation weights of the semantically-identical fields and semantically-similar fields, if any, in that combination.

In an aspect, the matching rules are identified only after the possible combinations are associated with a confidence score. In another aspect, where the matching rules are applied only after the matching rules are identified.

In an aspect, the matching rules are ordered based on their respective confidence scores, and the set of correlated contact records are identified by iteratively applying the matching rules in order. In another aspect, the set of correlated contact records identified in each iteration is removed from the sets of contact records to be considered in the next iteration.

In an aspect, the method further comprises the step of updating the value in the first contact record in the pair with the value from the second contact record in the pair, for each pair of contact records in the set of correlated contact records. In another aspect, the method further comprises the steps of identifying those contact records in the first contact set that have no match to a contact record in the second contact set, and identifying those contact records in the second contact set that have no match to a contact record in the first contact set.

In an aspect, the method further comprises the step of merging the pairs of correlated contact records into a third set of contact records by applying one or more precedence rules, where the precedence rules are defined to resolve field conflict resolutions between the first and second sets of contact records. In another aspect, the preference rules are applied in order, and the order is based on the reliability of the data in the first and second contact record sets.

In another preferred embodiment, the invention provides a method of identifying a set of correlated contact records from a first set of contact records having a first set of fields and a second set of contact records having a second set of fields, where the method comprises the steps of: (i) identifying up to N pairs of semantically-identical fields, where one member of each pair is selected from the first set of contact record fields and the other member of each pair is selected from the second set of contact record fields; (ii) for at least one pair of the semantically-identical fields, calculating a value that models the likelihood that a record in the first set of contact records matches a record in the second set of contact records, given a match of values in the pair of semantically-identical fields; (iii) determining if there are fewer than N pairs of semantically-identical fields; (iv) if there are fewer than N pairs of semantically-identical fields, identifying zero, one or more pairs of semantically-similar fields, where one member of each pair is selected from the first set of contact record fields and the other member of the each pair is selected from the second set of contact record fields, such that the sum of the pairs of semantically-identical fields and the pairs of semantically-similar fields is less than or equal to N; (v) for at least one pair of the semantically-similar fields, if any, calculating a value that models the likelihood that a record in the first set of contact records matches a record in the second set of contact records, given a match of values in the pair of semantically-identical fields; (vi) identifying up to 2^{N} possible combinations of semantically-identical fields and semantically-similar fields, if any; (vii) for at least one of the possible combinations, calculating a product of the calculated values for the semantically-identical fields and the semantically-similar fields, if any, in that combination; (viii) ranking the set of possible combinations by their respective calculated product probabilities; (ix) selecting a threshold record match probability; (x) identifying one or more matching rules, where each matching rule is one of the possible combinations of semantically-identical fields and semantically-similar fields, if any, and where the calculated product probability is greater than or equal to the threshold record match probability; and (xi) iteratively applying one or more of the matching rules in the order of highest to lowest record match probability, to identify a correlated set of contact records, where each matching rule is applied by selecting pairs of contact records from the first and second sets of contact records where the values match on all of the semantically-identical fields and semantically-similar fields, if any, in that matching rule.

In an aspect, the matching rules are identified only after all the record match probabilities are calculated. In another aspect, the matching rules are applied only after all of the matching rules are identified. In yet another aspect, the set of correlated contact records identified in each iteration is removed from the sets of contact records to be considered in the next iteration.

In as aspect, the method further comprises the steps of: updating the value in the first contact record in the pair with the value from the second contact record in the pair for each pair of contact records in the set of correlated contact records; identifying those contact records in the first contact set that have no match to a contact record in the second contact set; and identifying those contact records in the second contact set that have no match to a contact record in the first contact set.

In another aspect, the method further comprises the step of merging the pairs of correlated contact records into a third set of contact records by applying one or more precedence rules in order, where the precedence rules are defined to resolve field conflict resolutions between the first and second set of contact records. In still another aspect, the precedence rules further define whether conflicting data that is not included in the third contact set is discarded or preserved.

In an aspect, the method further comprises the step of associating an augmentation data set with the first set of contact records, such that values in the data set can augment values in the records of the first set of contact records. In another aspect, the method further comprises the step of associating an augmentation data set with the first set of contact records, such that any augmentation value is preserved until the underlying data in a matched contact record is changed.

In a preferred embodiment, the invention provides a method of identifying a set of correlated contact records from a first set of contact records having a first set of fields and a second set of contact records having a second set of fields, where the method comprises the steps of: (i) identifying up to N pairs of matching fields, where one member of each pair is selected from the first set of contact record fields and the other member of each pair is selected from the second set of contact record fields; (ii) calculating a field correlation weight for at least one of the matching fields, where the field correlation weight represents the probability that a matching value in this field indicates a match between two contact records having a matching value in this same field; (iii) identifying up to 2^{N} possible combinations of the matching fields; (iv) after all the field correlation weights are calculated, calculating a record match probability for at least one of the possible combinations as the product of the field correlation weights calculated for the matching fields in that combination; (v) after all the record match probabilities are calculated, ranking the set of possible combinations by their respective record match probabilities; (vi) selecting a threshold record match probability; (vii) after all of the possible combinations are ranked, identifying one or more matching rules, where each matching rule is one of the possible combinations of matching fields, and where the record match probability is greater than or equal to the threshold record match probability; (viii) after all of the matching rules are identified, iteratively applying one or more of the matching rules in the order of highest to lowest record match probability, to identify a set of correlated set of contact records, where each matching rule is applied by selecting pairs of contact records from the first and second sets of contact records where the values match on all of the matching fields in that matching rule; and (ix) removing the sets of contact records identified in each iteration from the sets of contact records to be considered in the next iteration.

The detailed description provided below, in connection with the appended drawings, is intended as a description of the embodiments of the invention and is not intended to represent the only form in which the present invention may be constructed or utilized. The description sets forth the functions of the invention and the sequence of steps for constructing and operating the invention in connection with the illustrated embodiments. However, the same or equivalent functions and sequences can be accomplished by different embodiments that are also intended to be encompassed within the spirit and scope of the invention.

Although the present invention is described and illustrated herein as being implemented in a database server and associated web user interfaces, the system described is provided as an example and not a limitation. As those skilled in the art will appreciate, the present invention is suitable for application in a variety of different types of personal, main-frame or distributed computer systems. For example, a distributed computer system that allows a user to access a contact store through an internet connection is contemplated.

### BRIEF DESCRIPTION OF THE DRAWINGS

The foregoing and other features and advantages will be apparent from the following more particular description of exemplary embodiments of the disclosure, as illustrated in the accompanying drawings, in which like reference characters refer to the same parts throughout the different views. The drawings are not necessarily to scale, emphasis instead being placed upon illustrating the principles of the disclosure.

FIG. 1 is a conceptual block diagram of a Contact List Refresh system and method, in accordance with an embodiment of the invention;

FIG. 2 is a conceptual block diagram of a Contact List Merge system and method, in accordance with an embodiment of the invention;

FIG. 3 illustrates an example of local overrides being used to augment an existing contact record, in accordance an embodiment of the invention;

FIG. 4 is a flow chart illustrating a Contact List Refresh method, in accordance with an embodiment of the invention;

FIG. 5 is an example of contact records in both a new and existing version of a contact list, used to illustrate the Contact List Refresh method of FIG. 4;

FIG. 6 is an example of a matching rule table based on the example of FIG. 5;

FIG. 7 illustrates the multiple iterations used to generate a set of contact list matches, additions, and deletions, in accordance with the invention of FIG. 4;

FIG. 8 illustrates disparate overlapping contact sources;

FIG. 9 illustrates a merged contact record, created from the overlapping contact sources shown in FIG. 8;

FIG. 10 is a flowchart illustrating a Contact List Merge method, in accordance with an embodiment of the invention;

FIG. 11 is an example of two contact lists and their common fields, used to illustrate the Contact List Merge method of FIG. 10;

FIG. 12 illustrates hypothetical correlation weights for the common fields of FIG. 11;

FIG. 13 an example of a matching rule table based on the example of FIG. 12;

FIG. 14 is an example of contact records in two contact lists, used to illustrate the Contact List Merge method of FIG. 10; and

FIG. 15 illustrates the use of the Local Override Store in connection with the Contact List Refresh method of FIG. 4.

### DETAILED DESCRIPTION OF PREFERRED EMBODIMENTS

Contact List Refresh

A contact is typically a single person, group, organization, or their equivalent. A contact record typically consists of, but is not limited to, a Name (e.g., Title/First Name/Last Name/Middle Name/Name Prefixes/Name suffixes and Nicknames), phone numbers (e.g., Work/Cell/Home/Pager), Emails (e.g., Official/Personal), and Addresses (e.g., Work/Home/Mailing). Additional, application-specific fields, such as Date of Hire and Marital Status for employees, may also be included. To operate efficiently, an organization must keep its contact information up-to-date. Contact data, therefore, must be refreshed from time to time with the latest and most accurate information.

As described in detail below, the Contact List Refresh system and method of the invention maintains a set of locally added augmentation data as an overlapping layer on a set of records that are imported from an input data source. Locally added data can be used to override a value in an imported contact record, or to add missing information not present in an imported contact record. The locally added, or augmentation data, however, needs to be preserved until the underlying data from the input data source changes.

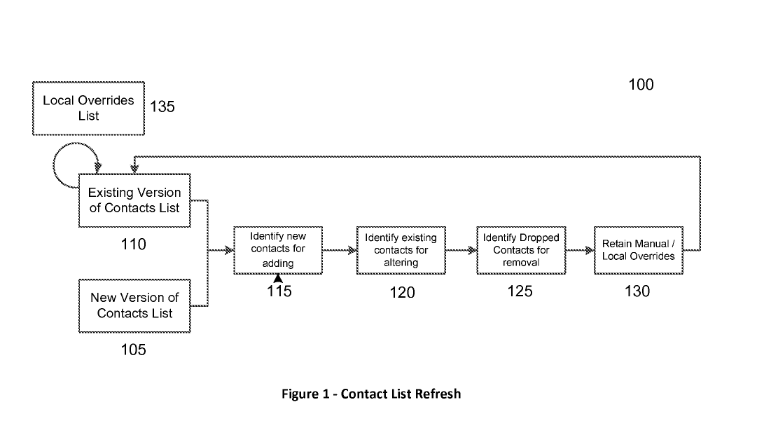

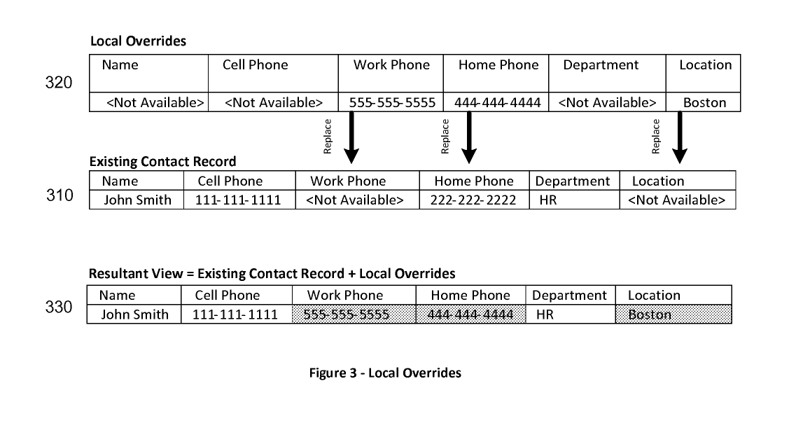

FIG. 3 illustrates an example of how local override data may be used to augment an existing contact record. As shown in FIG. 3, and with further reference to FIG. 1, Existing Contact Record 310 is an example of a record in the Existing Version of the Contact List 110. Existing Contact Record 310 has four populated fields: Name, Cell Phone, Home Phone, and Department. Two fields, however, in Existing Contact Record 310 are not populated: Work Phone and Location.

With further reference to FIGS. 1 and 3, Local Overrides 320 is an example of data in the Local Overrides List 135. Local Overrides 320 is associated with Existing Contact Record 310, and may, for example, represent information that is temporarily added to the local copy of the data. In this example, Local Overrides 320 has three populated fields: Work Phone, Home Phone, and Location. Note also the value for the Home Phone field in the Local Overrides 320 is different from the value for the Home Phone field in the Existing Contact Record 310.

The Resultant View 330 is the final view of the contact record that is provided to a consuming application or user. In this example, the Work Phone, Home Phone and Location fields in the Local Overrides 320 are used to augment these same fields in the Existing Contact Record 310 to produce the Resultant View 330.

The data from the Local Overrides 320 is layered on top of the Existing Contact Record 310, overriding data as appropriate. This layering is analogous to the concept of animation celluloid (cel) layering, where each layer contributes to the resulting image. In this case, the Existing Contact Record 310 and the Local Overrides 320 both contribute to the Resultant View 330.

In contrast with a simplistic contact refresh process, where a new set of records imported from an input data source would simply replace the existing set of records, the Contact List Refresh system and method of the present invention preserves the augmentation data until the underlying data from the imported data source changes.

Over time, any specific field to be relied on for establishing a match between records may change. For example, phone numbers may change with an upgrade in local equipment, and email and employee IDs may change as companies go through mergers or acquisitions. A major challenge, therefore, is to locate the same person's or entity's contact record accurately in both the new and existing versions of a contact list, so that any augmentation data is preserved, but without relying on a single identification field or key, or a fixed set of likely matching criteria, to identify the matching pair. The Contact List Refresh system and method described herein addresses this challenge by evaluating statistical evidence of each possible match presented by the contact source. In preferred embodiments, the invention assigns a probabilistic confidence score based on the combinations of the matching fields. By multiplying normalized statistical contribution weights for multiple fields, an overall confidence score can be generated for a match.

Comparing each input record to each existing record, evaluating its total likelihood of a match, and then sorting to find the best possible matches, while effective, may not be the most time efficient method, and will not scale with a large number of contacts. A different approach can be used to reduce the run time required for generating the set of matched pairs of contact records.

Specifically, in a preferred embodiment, and as described in detail below, the method examines the set of possible matching fields, and ranks the probability of a match given a match in each set of those fields, given the product of the contributed correlation weight for a match in each of the constituent fields. This generates a finite ordered set of matching criteria that can be evaluated so as to iteratively reduce the set of unmatched records, starting with the most obvious (such as, for example, “all fields match”), to less certain matches, until the method reaches a threshold where a match on the remaining fields would not meet a reasonable expectation of providing sufficient evidence to declare a match.

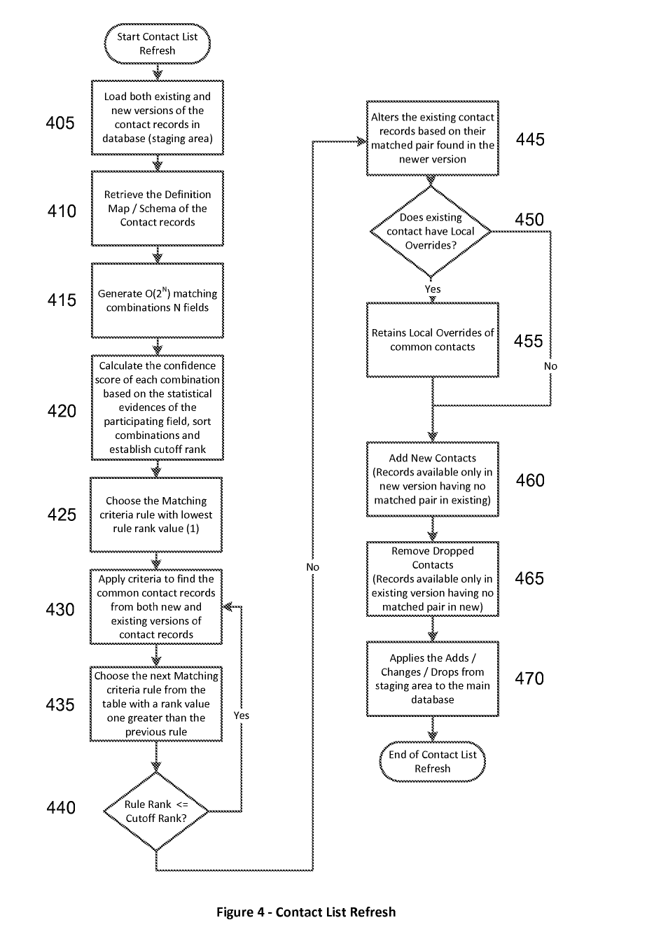

FIG. 4 illustrates a preferred embodiment of the steps in a Contact List Refresh method, in which a new set of contact data is correlated with an existing set of contact data, the set of matches is determined, and the additions, deletions, and changes to the existing set of contact data are computed.

As described in detail below, each existing contact record and new contact record is stored in the database, with the contact record fields represented in semantically identified columns within that database. A set of matching rules is determined by evaluating the probabilities of a contact record match given a match in a particular contact record field. In a preferred embodiment, a database engine is used to efficiently compute the set of matching pairs for each matching rule.

The method calculates the Confidence Scores for each combination, sorts the combinations to create the Matching Rule Table, and then establishes the Cutoff Rank. By pre-computing the Confidence Scores, sorting, and then evaluating matches in this order, a preferred embodiment of the method need not actually compute Confidence Scores during the actual matching process between records, and instead, only consider the rank of the rule being used to match, which is directly correlated to its Confidence Score. In a preferred embodiment, the inventive method uses a database and database queries to reduce the search time for finding matched pairs. The method iteratively performs simple queries, (e.g., SELECT queries) to find matching pairs that have matches on each of the fields in a given matching rule. The matching rules are evaluated in the order of highest to lowest probability of match. After the matching rules are applied, the resulting sets of matched records, records to be added, and records to be dropped, are processed to refresh the existing contact list.

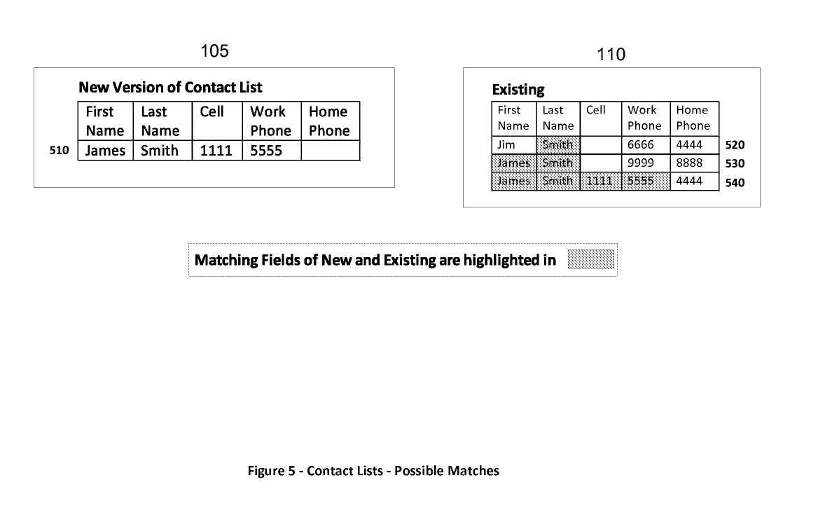

An exemplary set of records, shown in FIG. 5, are used in the following detailed description. It is understood, however, that this simple illustration does not limit the scope of the invention.

As shown in FIG. 5, Contact Record 510 in New Version of Contact List 105 matches partially with three different Contact Records 520, 530, and 540 in Existing Version of Contact List 110. Specifically, Contact Record 520 in the Existing Version 110 matches with the newer Contact Record 510 on Last Name only. Contact Record 530 in the Existing Version 110 matches with the newer Contact Record 510 on both First Name and Last Name, and Contact Record 540 in the Existing Version 110 matches with the newer Contact Record 510 on four fields, First Name, Last Name, Cell, and Work Phone.

Apart from normal human data entry error, there could be various reasons for having these incomplete records, and therefore only partial matching. For example, James Smith might have entered his contact information more than one time in the contact entry system, at different times, by mistake. While entering the information, James might have used his nickname ‘Jim’ or just the initial of first name ‘J’ instead of his full formal name. It is also possible that James Smith, J Smith, and Jim Smith are three different persons.

The matched contact pair with the highest confidence score is considered to be the pair that refers to the same person or entity. In the example of FIG. 5, Contact Record 540 will be considered to match to Contact Record 510 if the combination of First Name, Last Name, Cell, and Work Phone has a higher confidence score than either: (1) the confidence score of Last Name only, as for Contact Record 520, or (2) the confidence score of the combination of First Name and Last Name, as for Contact Record 530.

Returning to FIG. 4, and with further reference to FIG. 1, in step 405, both the Existing Version 110 and the New Version 105 of the Contact List records are loaded into a database staging area. At step 410, a definition map or schema for the database is retrieved. The retrieved schema is used as a semantic content map to translate each field in an input contact list into a set of semantic fields. Steps 405 and 410 may together be referred to as importing the input data sources.

At step 415, the method generates a Matching Rule Table with O(2^{N}) rows, where each row represents finding a match in some combination of up to N fields that can be used for matching two contact records. (The O(2^{N}) notation is used because in some instances there may not be exactly 2^{N} rows to use for matching, as described in detail below.)

In step 420, the method calculates a Confidence Score for each of the matching combinations based on statistical evidence, sorts the results into a Matching Rule Table to prioritize the set of comparisons to make, and establishes a threshold point in the Matching Rule Table called the Cutoff Rank.

In calculating matching rule Confidence Scores, what is needed is a measure of how unique a value is likely to be in any given field, and therefore how discriminating that field can be when trying to make matches. Because of the mechanics of multiplying probabilities, in a preferred embodiment, the field correlation weights used to calculate the Confidence Scores model the probability that any given value in that field will be non-unique. Thus, the lower the value of the field correlation weight, the better the weight is for helping to discriminate between records. By multiplying these field correlation weights together, the method can then calculate the probability that any given set of values in those fields will be non-unique. That is, the smaller the product of the field correlation weights, the smaller the chance that a match on all of those fields could be confused with some other contact record. The Confidence Score for each matching rule is therefore defined as one (1.0) minus the field correlation weight product for that rule. The Matching Rule Table of possible combinations and associated Confidence Scores may be generated and sorted prior to the actual record matching process, so that each rule is given a prioritized Matching Rule Rank. By using Matching Rule Rank to represent discrete confidence scores, in a preferred embodiment, the method does not then need to actually calculate or compare these Confidence Scores during the matching process.

This ordering of the Matching Rule Table, described in detail below, allows the method to iteratively remove the best matches first, and then work its way through to more uncertain matches as it progresses, until all rules with a sufficiently high Confidence Score have been evaluated.

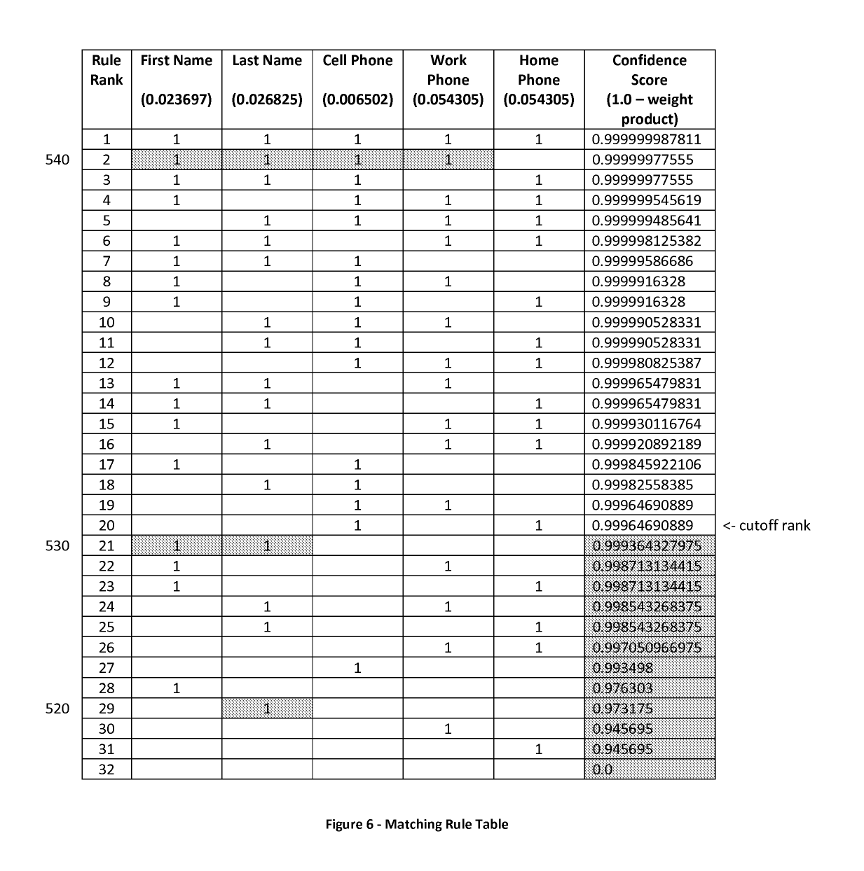

Continuing with the example, FIG. 6 provides a Matching Rule Table 600 for the data in FIG. 5. In this example, five fields in the contact records are used as matching criteria (First Name, Last Name, Cell Phone, Work Phone, and Home Phone) and therefore N, the number of fields that can be used for matching, is five (5). There are 2⁵ or thirty-two (32) matching combinations, and each combination is represented by a row in the Matching Rule Table 600. Each field used for matching is represented by a column in Matching Rule Table 600. Note that there may be additional fields in the contact records, for example, Date of Hire and Marital Status, but in this example, only these five fields have been selected to be used to determine the matching records. In a preferred embodiment, the set of fields used as matching criteria is configurable, and may include all or less than all of the possible fields in the contact records.

In theory, the chances of finding matching records could be improved by looking for matches between all the values in every possible pair of fields. However, increasing the number of comparisons without restrictions could overwhelm the computational tractability of the solution; in the worst case, this could lead to O(2^{P}) (where P=2^{N}) combinations to consider. To bound the set of matching rules to consider to O(2^{N}), the number of field pairs being compared, and therefore the number of component field correlation weights, is limited to some small number N, so that the method produces up to 2^{N} rules when computing the Confidence Scores for these weights in combination.

In some instances there may not even be N semantically-identical fields to match on. In this situation, the method accommodates the correlation of fields that share a common semantic type, such as matching a primary first name in one set of records to an alternate first name in another set of records, or matching a cell phone with a home phone. These are considered semantically-similar fields.

As described in detail below, if there are less than N non-empty fields considered to be matchable, semantically-identical, fields, the method may generate additional field correlation weights, called cross-column correlation weights, for these type-compatible, semantically-similar fields. The method then selects those matches having the best correlation weight to bring the number of correlation weights considered up to a maximum of N in total. (In this context, the “best” correlation weight is one that indicates the smallest probability of a non-unique value in each field of the pair being compared.) These cross-column correlation weights are chosen to be slightly worse than correlation weights computed for semantically-identical fields but allow for generating more ways of detecting a match in the event there are relatively few correlatable fields. (In contrast to “best,” the “worst” correlation weight is one that indicates the highest probability of a non-unique value in each field of the pair being compared). In this way, the method keeps the number of rules and evaluations bounded.

This process of using cross-column correlation weights is discussed in detail below for the Contact List Merge, but is not illustrated in this simple Contact List Refresh example, which focuses on the basic matching process itself; the process of matching rule generation, ranking and evaluation is identical whether the method uses exact-match comparisons or cross-column comparisons.

As shown in FIG. 6, each field has an associated hypothetical field correlation weight. First Name has a hypothetical field correlation weight of 0.023697, Last Name has a hypothetical field correlation weight of 0.026825, Cell Phone has a hypothetical field correlation weight of 0.006502, and Work Phone and Home Phone each have a hypothetical field correlation weight of 0.054305. In this example, then, a match on the Cell Phone field contributes a higher probability of a contact record match than a match on any of the other fields, because its weight (representing the likelihood that any given Cell Phone value will be non-unique) has the smallest value. Note that these field correlation weights are used for illustration only, and in preferred embodiments, these values are computed based on the data available.

Each cell in the Matching Rule Table 600 with a value of “1” represents a matching field. Row Number 1, therefore, represents the matching criteria where all five fields match in both the new and existing versions of the contact record, and Row Number 32 represents the combination where none of the contact record fields in the new and existing versions of the contact record match. Because the Matching Rule Table is sorted by Confidence Score, the row number of each entry in the table becomes the prioritized rank of that rule, directly corresponding to the Confidence Score that the rank represents. With further reference to FIG. 6, the rule with Matching Rule Rank (row number) 1 has a larger Confidence Score than the rule with Matching Rule Rank (row number) 2, but the value of the Matching Rule Rank for row number 1 (value=1) is less than or lower than the value of the Matching Rule Rank for row number 2 (value=2).

The rightmost column in Matching Rule Table 600 represents a Confidence Score. As described above, the Confidence Score is calculated as one (1.0) minus the product of the correlation weights for each matching field. For example, the Confidence Score for the matching rule with rank (row number) 16, where the Last Name, Work Phone, and Home Phone fields match, has a Confidence Score of 0.999920892189, computed as 1.0 minus the product of 0.026825 (Last Name), 0.054305 (Work Phone) and 0.054305 (Home Phone). The matching rule with rank (row number) 1, where all five fields match, has a Confidence Score of 0.999999987811, while the matching rule with rank (row number) 32, where none of the contact record fields match, has a Confidence Score of zero (0).

As stated above, the Cutoff Rank is selected in step 420. In the example shown in FIG. 6, the Cutoff Rank is matching rule (row number) 20, with a Matching Rule Rank value of 20. Note that this value is used for illustration only, and in preferred embodiments, the Cutoff Rank is configurable. Row numbers 1 through 19 have Matching Rule Rank values of 1 through 19, respectively, and thus have lower or lesser rank values that the Cutoff Rank. Row numbers 21 through 32 have Matching Rule Rank values of 21 through 32, respectively, and thus have higher or greater rank values than the Cutoff Rank.

Continuing with the example of FIG. 5, and as shown in FIG. 6, the potential match for Contact Record 520 is represented by the matching rule with a Matching Rule Rank value of 29. As this rank value is higher or greater than the Cutoff Rank of 20, Contact Record 520 is not considered an acceptable match. Similarly, the potential match for Contact Record 530, represented by the matching rule with a Matching Rule Rank value of 21 also has a rank value that is higher or greater than the Cutoff Rank. Contact Record, 530, therefore, is also not considered an acceptable match.

The potential match of Contact Record 540, represented by the matching rule with the Matching Rule Rank value of 2, has a Confidence Score of 0.999977555, The Matching Rule Rank value of this rule is 20, which is less than or equal to the Cutoff Rank of 20, and therefore considered to be an acceptable match. In this example, the only way to improve on this match would be if all five of the fields considered in the example were to match another record in the contact set, which would be detected by the method in the preceding iteration of the rule evaluations, matching the rule with Matching Rule Rank (row number) 1.

The ability to configure the matching criteria and the Cutoff Rank based on the type of contact sources and their fields may enable the method to be more accurate and adaptable than existing methods. Correlation weights for each field are determined by statistically evaluating how well that field discriminates between contact records. For example, Employee ID fields are usually fairly good at discriminating between contact records, and so usually have a high contribution to matching. Similarly, email addresses are usually quite good discriminators. Note however, that both of these fields may change for an entire data set if a company is purchased or undergoes a merger, and in preferred embodiments, the Cutoff Rank is selected to require at least two matching fields to determine whether a match is acceptable. Because the weights are generated from statistical analysis, the computed confidence scores are therefore similarly derived, and reflect actual observation.

In additional embodiments, field correlation weights may be periodically reviewed and automatically adjusted as the data set changes and new evidence is presented, so as to ensure the best possible matching given evolving data conditions. Gradual adaptation may be used to adjust the weights, relying on correlation scoring based on many sets of input data seen over time. In additional embodiments, such a system may be built using neural network modeling or other deep-learning techniques to determine the best matching probability contributions.

With further reference to FIG. 4, the matching criteria rule with the lowest Matching Rule Rank value (i.e., rule or row number) is selected in step 425. In this example, the first Matching Rule, with a Matching Rule Rank value of 1 (row number 1) is selected.

With further reference to FIG. 4, steps 430, 435, and 440 represent a sequence of steps that are performed in a loop. In the first iteration, at step 430, those contact records matching on all fields in the current matching rule, and therefore representing the set of best possible matches, are selected first. The records matched in step 430 are then removed from consideration before the next iteration of the loop.

The next rule in the set of Matching Rules is selected at step 435. The selected rule is the one with the Matching Rule Rank that is one higher or greater than the previous Matching Rule Rank. Continuing with the example, the Matching Rule with a Matching Rule Rank that is one higher or greater than the first Matching Rule is the Matching Rule with a Matching Rule Rank of 2 (row number 2).

At step 440, the rank value of the selected rule is compared to the Cutoff Rank. If the rank value of the selected rule is less than or equal to the Cutoff Rank, the method continues to step 430, and the process continues. The remaining unmatched records are matched on the set of fields providing the next highest available confidence of a match, and so forth, until the cutoff for the probability of any matches being made is reached.

At step 440, if the rank value of the selected rule is greater than the Cutoff Rank, the method proceeds to step 445.

By way of example, in the first iteration, those contact records matching on all five fields (First Name, Last Name, Cell Phone, Work Phone, and Home Phone) are selected first. The next rule selected at step 435 may be to select those contact records that match on the following four fields: First Name, Last Name, Cell Phone, and Work Phone. As shown in FIG. 6, the Matching Rule Rank value for this rule (row number) is 2. Applying step 440, the since the rank value of this rule (row number 2) is less than or equal to the Cutoff Rank of 20, the method proceeds to step 430, where the remaining unmatched records are matched on the set of fields specified in this rule.

Steps 430, 435, and 440 repeat until the rank value of the rule selected in step 435 is greater than the Cutoff Rank. For example, if the rule selected at step 435 is to select those contact records that match on only two fields, First Name and Last Name (as represented by matching rule (row number) 21 in FIG. 6), the method proceeds to step 445.

This sequence of steps rapidly reduces the set of comparisons that need to be made. The number of iterations is linearly bounded by the number of combinations of available, semantically useful fields. For example, if N is the number of possible contact record fields to compare for any two contact lists, then the number of combinations is 2^{N}, as shown by the rows in FIG. 6.

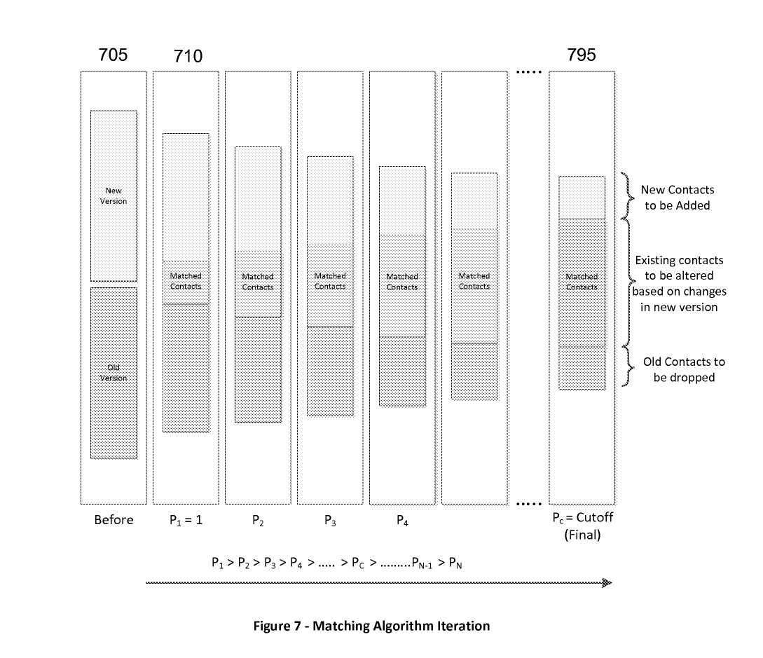

FIG. 7 illustrates the matching algorithm iteration, and demonstrates how this process proceeds linearly through the matching rules, stopping at a given cutoff point to then generate the resulting set of contact list matches, additions, and deletions. Each value of P represents a rule rank or row number, and P_{c} represents the Cutoff Rank. Bar 705 represents the two sets of contacts, new and existing, before any matching rules are applied. Bars 710 through 795 each represent one loop through steps 430, 435, and 440, where the set of matched records grows until the method reaches the defined match probability cutoff point at bar 795. At bar 795, the end of the matching algorithm, there are three sets of contact records:

(i) contacts to be added, which consists of contact records in the new version of the contact list that were not matched with any contact records in the existing version of the contact list;

(ii) matched contact records, which are contact records that are present both the existing and new versions of the contact list; these contact records may need to be altered based on changes identified in the new version of the contact list; and

(iii) contacts to be dropped, which consists of contact records in the existing version of the contact list that were not matched with any contact records in the new version of the contact list

In steps 445 through 470, these three sets of contact records are processed to refresh the existing version of the contact list in the database staging area.

At step 445, the matched contact records in the existing version of the contact list in the database staging area are updated, if necessary, with the new version of the data. At steps 450 and 455, for all the records which are changed, the method evaluates the local overrides list to determine if the overrides or augmentations for those records should be retained. If the underlying field has changed in the new version of the contact list, then the local data override is removed, as it is assumed that the new data is more current, and should replace the override data. In this way, the system automatically converts local information to new information, should that same data be made a permanent part of the imported new version of the contact list, and updates to old, and possible inaccurate data will automatically replace any override data.

At step 460, new contact records, which are the contact records that are available only in the new version of the contact list and have no matched record in the existing contact list, are added to the existing version of the contact list in the database staging area.

At step 465, contact records in the existing version of the contact list that have no matched record in the new contact list are dropped from the existing version of the contact list in the database staging area.

At step 470, the additions, deletions, and changes made to the existing version of the contact list in the database staging area are applied to existing version of the contact list in the main area in the database.

The method described above uses the database mechanics to correlate entire sets of records efficiently, rather than comparing individual records (for example, by using a computer program to compare each record with every other record to find the best match) to find each set of records having matches between each possible set of fields in combination, and, when the complexities of the query execution implementation in the database are ignored, the iteration process to find successive sets of matches proceeds linearly, evaluating up to only 2^{N} matching rules in the form of database queries, where N is the number of possible correlatable field pairings, generating 2^{N} sets of matching fields (matching rules) to be evaluated.

Further, in additional embodiments, the list of matching criteria can be optimized to only include combinations where some data is present for each field involved in that match criteria, thus further reducing the number of iterations (effectively reducing N). For example, the Matching Rule Table in FIG. 6, has a set of rows that that provide an overall confidence if the cell phone field matches. However, if, neither the new contact record set nor the existing contact record set have any values in the cell phone field, then these matching criteria rows can be removed from consideration when evaluating matches. This analysis is done as a precomputation, before matching begins, thus further improving the operational performance of the match.

Contact List Merge

Another challenge faced by many organizations is the partial duplication of contact data across multiple systems, where each system may serve a different primary function. For example, a person may have records in all of the following systems: the organization's Human Resources (HR) database, the telephone system, and the billing system. Each of these systems may have data specific to that system's needs, may have varying representations of the same information, and may be updated independently of the other systems, causing one or more sources to accumulate stale data over time. It is desirable, then, to be able to merge these disparate contact data sources to create a combined “best of” set of contact data.

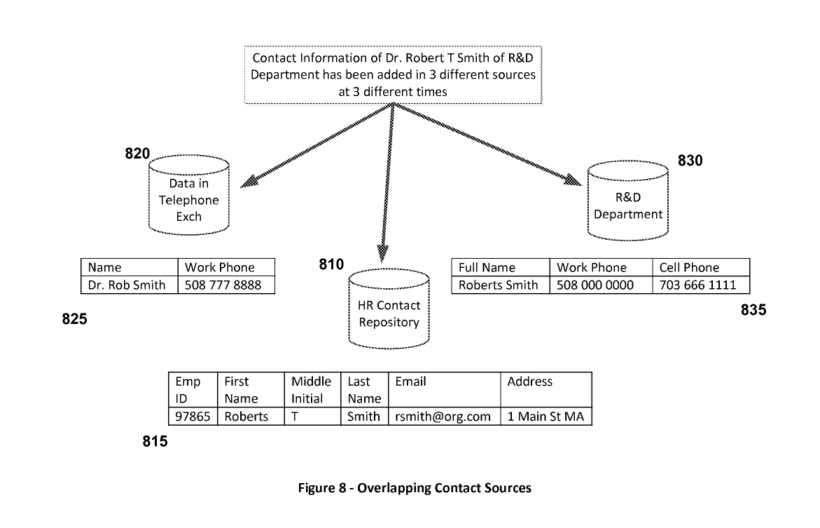

FIG. 8 illustrates an example of disparate overlapping contact sources, where the same person's information has been entered into multiple different systems. As a result, these multiple systems have different versions of the contact information for the same person. Such multiple representations of a person or entity may be referred to as conflicting or duplicate contacts.

In this example, the contact information of Dr. Robert T Smith has been entered into different repositories or systems at different times. As shown in FIG. 8, the HR Contact Repository 810 has a correct contact record 815 comprising the Employee ID, First Name, Middle Initial, Last Name, Email Address and Home Address. The Telephone Exchange Repository 820 has a contact record 825 comprising a correct Work Phone Number, and an Alternate or “nickname” in the Name field. The Research and Development (R&D) Department Repository 830 has a contact record 835 comprising a Full Name, an out-of-date Work Phone Number, and a correct Cell Phone Number.

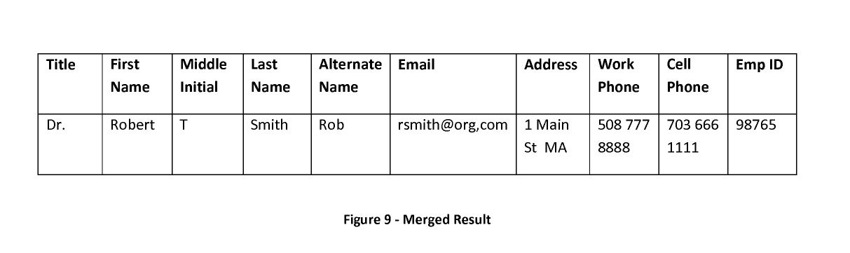

FIG. 9 illustrates the merged contact information for Dr. Robert T. Smith, where the data from the different contact sources has been merged such that substantially all of the information is contained in a single contact representation, shown as contact record 910. Contact record 910 comprises the correct Work Phone Number, the correct First Name, and an Alternate Name.

To accomplish this merge, the inventive method described herein identifies the same contacts in heterogeneous sources using dynamic matching criteria to find duplicate contacts, then resolves the conflicting multiple versions of the same information while preserving the most accurate information.

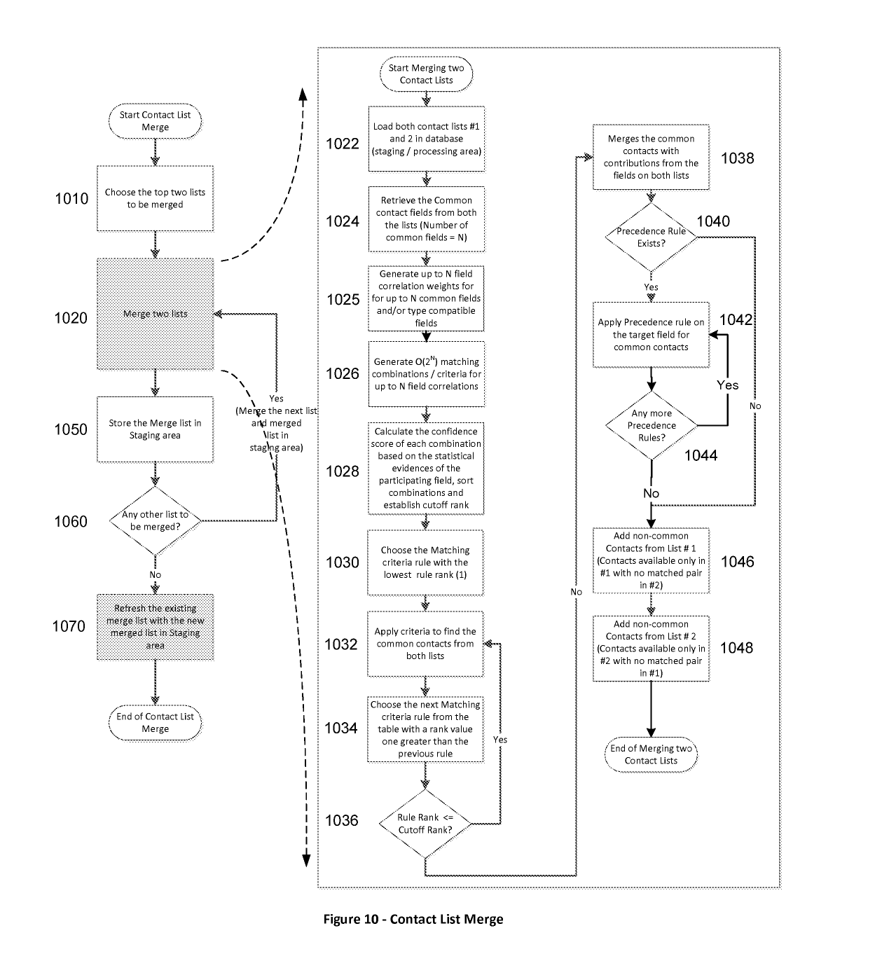

FIG. 10 illustrates a preferred embodiment of the steps in a Contact List Merge method, in which dissimilar contact lists are merged to produce a new merged contact list. The Contact List Merge method of the invention also includes steps to refresh the merged contact list over time, to accommodate changes in the underlying contributing lists. The Contact List Merge method described below builds upon the Contact List Refresh Method (described above).

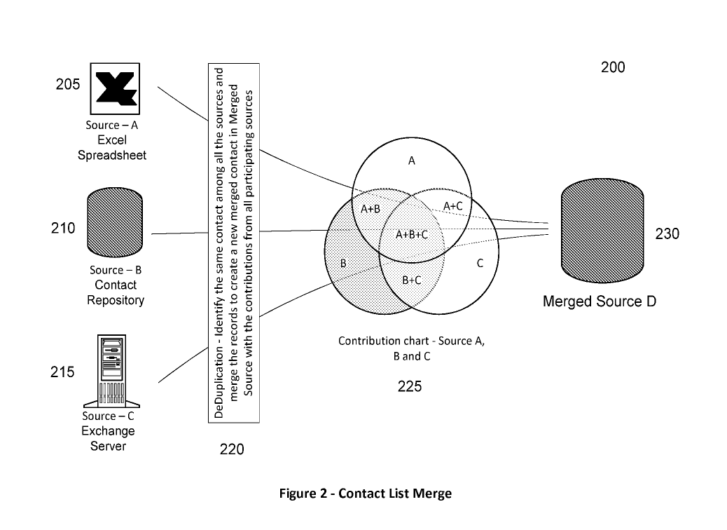

At step 1010, the first two contact lists to be merged are chosen. The set of contact lists, and the order in which they are merged, are part of the merge specification, the set of information that must be provided to the Contact List Merge process prior to performing the merges. For example, and with reference to FIG. 2, the set of contact lists to be merged may be Contact List A 205, Contact List B 210, and Contact List C 215. The order in which the contact lists are merged affects the way conflicts are resolved. For example, the order may be (1) Contact List B 210, (2) Contact List A 205, and (3) Contact List C 215. If Contact List B 210 and Contact List A 205 are merged first, the result is a new transient list (210+205). Since Contact List B 210 is higher in order, contact record fields from Contact List B 210 will take precedence over contact record fields from Contact List A 205. In the next iteration of the merge, this transient list (210+205) will be merged with Contact List C 215, and contact record fields from the transient list (210+205) will take precedence over contact record fields from Contact List C 215. The first two contact lists are merged in step 1020, which is comprised of a series of sub-steps, shown as steps 1022 through steps 1048.

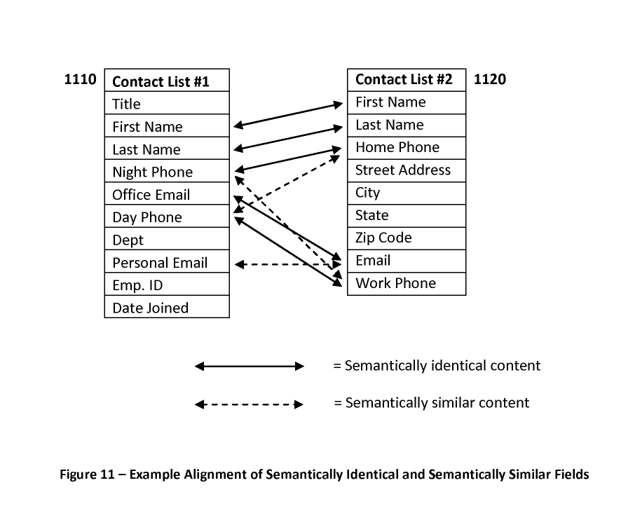

At step 1022, both of the selected contact lists are loaded into a database staging area. At step 1024, a set of common contact fields from both of the Contact Lists is retrieved. For example, and as shown in FIG. 11, two contact lists, Contact List 1 1110 and Contact List 2 1120, have been chosen for the merge. The two lists have five fields in common: First Name, Last Name, Night Phone/Home Phone, Day Phone/Work Phone, and Office Email/Email. These five fields are considered to overlap, in that they should represent the same information. In this step, it is important to understand that, in a preferred embodiment, the method maps these overlapping fields or columns according to their semantic content (as shown by the solid, double-arrow lines in FIG. 11), rather than the column's label in the respective sources. In a preferred embodiment, this semantically-identical content mapping, as well as the type-compatible content mapping discussed below, is established prior to performing the merge.

In one embodiment, this set of five semantically-identical content (exact match) fields would result in five (5) field correlation weights to consider, and therefore, 2⁵ (32) combinations of field matches to evaluate. In a preferred embodiment, however, the method also considers type-compatible fields (semantically-similar) or content.

For example, in FIG. 11, Contact List 1 contains a Personal Email field, and because email addresses are considered to be type-compatible, the Personal Email field in Contact List 1 may be used in cross-column matching with the Email field in Contact List 2 (as shown by the dotted, double-arrowed line). There may be instances where a given contact in Contact List 1 has a Personal Email value that was entered into Contact List 2 as simply Email. If the method only evaluated same semantic content (exact) matches, a match between the Personal Email field in Contact List 1 and the Email field of Contact List 2 would not be considered. Note that in this example, there are two additional sets of type-compatible fields: Night Phone (Contact List 1) and Work Phone (Contact List 2), and Day Phone (Contact List 1) and Home Phone (Contact List 2).

At step 1025, then, in a preferred embodiment, the method will compute (1) field correlation weights for the semantically-identical (exact match) fields, and (2) if there are less than N correlatable non-empty fields, zero, one, or more cross-column correlation weights for type-compatible, semantically-similar fields. Those contributing the highest probability of discriminating between records will be considered first for generating cross-column matching rules, thus expanding the matching rules table to consider up to N types of field matches in combination, thus bounding the number of matching rules up to 2^{N}. This method of pre-calculating the evaluations to perform also allows record pairs with more than one highly correlatable field to be identified as matching more readily and with higher confidence than those with fewer such correlatable fields.

As described above for Contact List Refresh, correlation weights for cross-column matches are computed to be slightly less than the correlation weights for their corresponding semantically-identical (exact match) counterparts, under the assumption that cross-column matches are less reliable than semantically-identical matches. Using different correlation weights also enables the matching combinations to be sorted. These correlation weights are then sorted so that only those possible matches having the best correlation weights (i.e., having the lowest probability of non-uniqueness) are kept, up to a limit of N correlation weights.

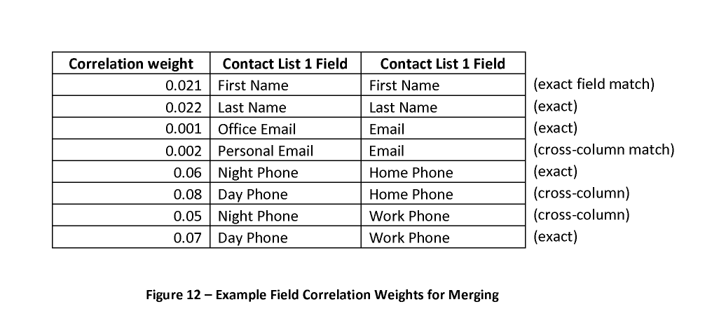

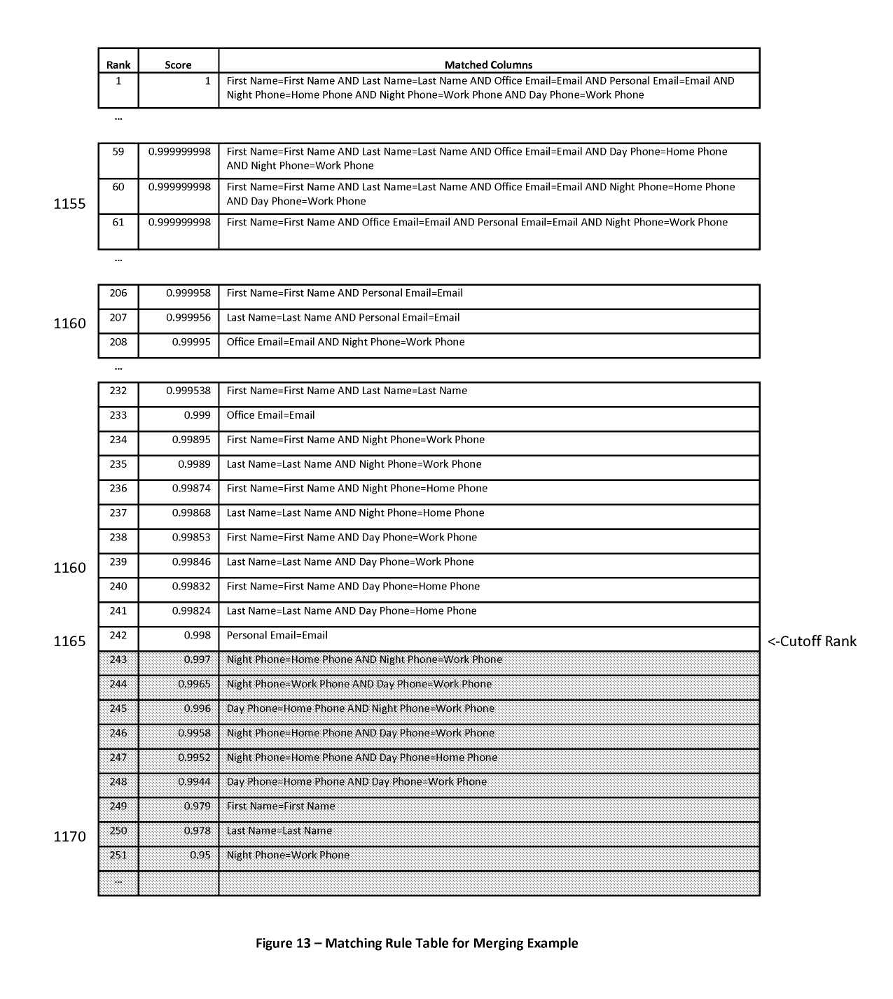

FIG. 12 provides a hypothetical set of field correlation weights for (i) the five same semantic content (exact) matches and (ii) the three cross-column (type-compatible) matches for the contact lists shown in FIG. 11. As described below, these correlation weights are used to generate the Matching Rules Table shown in FIG. 13.

At step 1026, the method generates a Matching Rule Table with O(2^{N}) rows, where N is the total number of field weights (the sum of the weights for semantically-identical field pairs and the semantically-similar field pairs) considered in combination. Continuing with this example, then, FIG. 8 shows eight (8) correlation weights, and therefore up to 256 (2⁸) Matching Rules. (Note some rules may be removed if there is no actual data present in a given column, and rules below the Cutoff Rank will not be evaluated.)

As with the Contact List Refresh Method, at step 1028, the method calculates a Confidence Score for each of the 2^{N} matching combinations, sorts the results into a Matching Rule Table to prioritize the set of comparisons to make, and establishes a threshold point in the Matching Rule Table called the Cutoff Rank. The Confidence Score, described in detail below, is an indication of the confidence that two records represent the same contact.

Continuing with the example, and as shown in FIG. 12, if the First Names in Contact List 1 and Contact List 2 match, the hypothetical correlation weight contributing to the confidence that the two records represent the same contact is 0.21; if the Last Names in Contact List 1 and Contact List 2 match, the hypothetical correlation weight is 0.22; and if the Office Email in Contact List 1 matches the Email in Contact List 2, the hypothetical correlation weight is 0.001.

Note that in this example, the Personal Email in Contact List 1, can also be compared to the Email in Contact List 2, because both are email addresses and type-compatible, as described above. In this case, the hypothetical correlation weight for this type of match is set to 0.002, i.e., slightly worse than for the exact column match of 0.001 for Office Email and Email. Similarly, the various phone number fields may match in a number of ways. The Night Phone in Contact List 1 can be compared to both the Home Phone (as an exact match) and the Work Phone (as a cross-column match) in Contact List 2. Each of these comparisons has a different associated correlation weight. Similarly, the Day Phone in Contact List 1 can be compared to either the Work Phone (as an exact match) or the Home Phone (as a cross-column match) in Contact List 2.

This approach of extending match comparisons to allow for cross-column matching provides a better chance of finding matching records in a situation where one of the sources being merged has type-compatible, but not identical, fields. In the example, if all eight of the field correlations between Contact List 1 and Contact List 2 are found, the two contact records would be considered to be a perfect match. Such a perfect match case would have the maximum Confidence Score (theoretically, a value of 1.0) for being the contact information for the same person. (This would also mean that data between the semantically similar fields was identical across all of these columns.) Conversely, if none of those field correlations are found, the Confidence Score for the two contact records being the contact information for the same person is zero (0). Note that these correlation weights are calculated based on currently available data, and in preferred embodiments, these values are configurable.

FIG. 13 shows an example of a Matching Rules Table generated from the correlation weights shown in FIG. 12. This format of this table is slightly differently than that the Matching Rules Table shown in FIG. 6, to account for the addition of the cross-column correlations, but the basic principal and construction is the same. The Confidence Scores are computed as one (1.0) minus the product of the field correlation weights considered for each Matching Rule, and then the Matching Rules are sorted by Confidence Score, and given a rule rank based on the rule's location in the Matching Rules Table. A Cutoff Rank is established, indicating the threshold rank value above which any further matches between fields is considered insufficient evidence of a contact record match. In the example, Matching Rules Table of FIG. 13, the Cutoff Rank is shown at location 1165, with a rank of 242 and a Confidence Score of 0.998, and represents a 1 in 500 theoretical probability of there being another match having the same two values in common. As with Contract List Refresh, the Cutoff Rank is configurable.

At step 1030, the matching criteria rule with the lowest Matching Rule Rank value (i.e., rule or row number) is selected. In this example, the first Matching Rule, with a Matching Rule Rank value of 1 (row number 1) is selected.

Steps 1032, 1034, and 1036 represent a sequence of steps that are performed in a loop. In the first iteration, at step 1034, those contact records matching on all common fields are selected. These contact records represent the set of best possible matches. The records matched in step 1032 are removed from consideration before the next iteration of the loop.

The next rule in the set of Matching Rules is selected at step 1034. The selected rule is the one with the Matching Rule Rank that is one higher or greater than the previous Matching Rule Rank. Continuing with the example, the Matching Rule Rank that is one higher or greater than the first Matching Rule is the Matching Rule with a Matching Rule Rank of 2 (row number 2).

At step 1036, the rank value of the selected rule is compared to the Cutoff Rank. If the rank value of the selected rule is less than or equal to the Cutoff Rank, the method continues to step 1032, and the process continues. However, if at step 1037, the rank value of the selected rule is greater than the Cutoff Rank, the method proceeds to step 1038.

As with Contact Refresh, this sequence of steps rapidly reduces the set of comparisons that needs to be made. The number of iterations is linearly bounded by the number of matching rules.

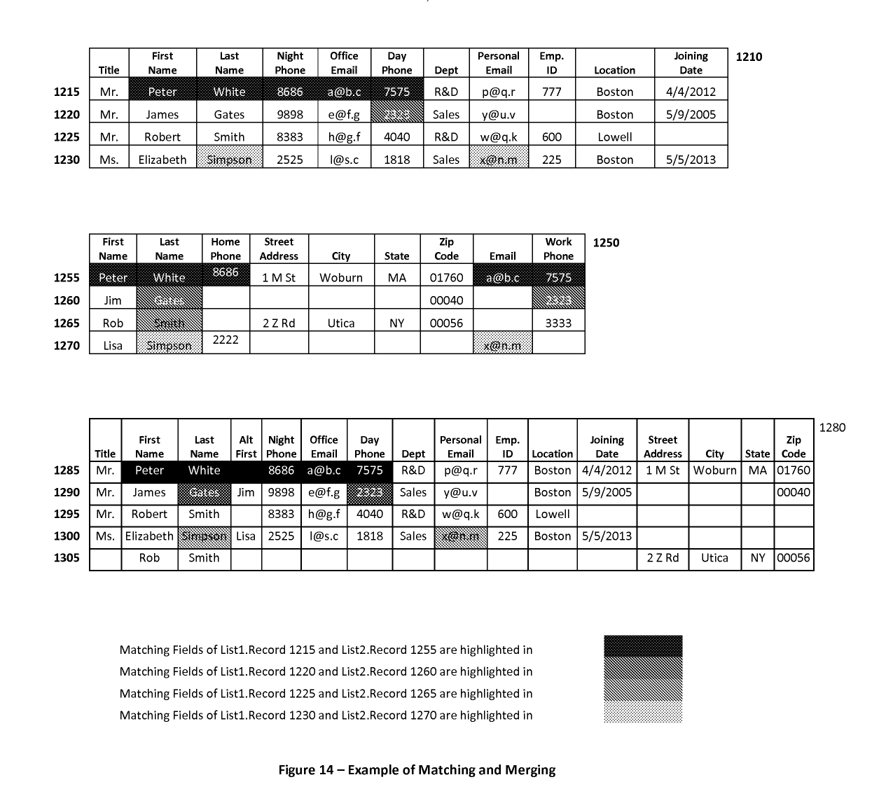

FIG. 14 illustrates the use of the Matching Rule Table to find matches. Two contact lists, Contact List 1 1210 and Contact List 2 1250, each with four records, are shown. Record 1215 in Contact List 1 and Record 1255 in Contact List 2 match on all five common (exact match) fields (First Name, Last Name, Night Phone/Home Phone, Day Phone/Work Phone, Office Email/Email). This match would be found with matching rule with rank 60 (1155 in FIG. 13). Record 1230 in Contact List 1 and Record 1270 in Contact List 2 match only on Last Name and Personal Email/Email. Note that this match involves a cross-column data match, but since it was discovered with Matching Rule 207 (FIG. 13 1160), which has a rank that is less than or equal to the Cutoff Rank (FIG. 13 1165), the two records will be merged. Record 1220 in Contact List 1 and Record 1260 in Contact List 2 match only on Last Name and Day Phone/Home Phone. This correlation would be found on the 239^{th} iteration of the matching loop, still less than or equal to the Cutoff Rank, and so would also result in a match and merge. However, Record 1225 in Contact List 1 and Record 1265 in Contact List 2 only match on Last Name, and so this correlation would be found on the 250^{th} iteration through the matching process (i.e., on the evaluation of matching rule 250), and since this rule (FIG. 13, 1170) has a rank value that is greater than the Cutoff Rank, this evaluation is not even performed; the records will not be matched, and the merged set of contacts will contain both records. Note that this example Cutoff Rank is for illustration only, and does not limit the scope of the invention.

At step 1038, the common contacts from the two lists are merged, using contributions from fields in both lists. Merging is the operation of retaining unique data by unifying one or more contacts into a single contact record for a person or other entity. To provide the “best set” of contact data, the merging process must include a mechanism for resolving conflicts. For example, two or more contacts may have different values for a field that should have only one correct, or true, value, and the process must decide which value is the correct one. Alternatively, a field may have many different values, all of which may be valid, and the process must decide which of the valid values to use.

Continuing with the example of FIG. 14, records 1230 and 1270 are considered a matched pair, because as described above, the rule rank at which they were matched is less than or equal to the Cutoff Rank. However, the method must determine whether to use the Office Email of Contact List 1 or the Email of Contact List 2 as the merged contact's Office Email address. Similarly, it must also determine which of the two First Name values it should pick as the merged contact's First Name, (and what to do with the other value.) To address this problem, the Contact Merge method uses configurable Precedence Rules, as shown in FIG. 10, steps 1040 through 1044.

A Precedence Rule may define an ordering of the contact sources for a given field, such that the most authoritative source of information for that field is given the highest precedence when resolving conflicting data, followed by the next most authoritative source, and continuing down to the source considered to have the least reliable data. Multiple Precedence Rules, which form part of the merge specification (described above), may be used to resolving conflicts. Precedence Rules specify which primary value wins, and can either discard the conflicting values or optionally indicate where to store them, in order to preserve potentially useful valid information, such as alternate names.

In step 1040, the method determines whether there are any Preference Rules to apply. If not, the method proceeds to step 1046. Alternatively, the method proceeds to step 1042, to apply the first Preference Rule to the common set of contact records.

Conflict resolutions in precedence rules may be of two different types: (i) one where the losing value is then discarded, and (ii) one where the losing value is stored elsewhere in the merged contact, so as to retain these additional values in the merged result, so as to provide the richest set of data possible in the resulting merged record.

For example, if a conflict exists between first names, such as “Robert” in Contact List 1, record 1225, and “Rob” in Contact list 2, record 1265, and the Precedence Rules give priority to Contact List 1, the First Name field will be set to “Robert,” and “Rob” will be preserved as an Alternate Name.

At step 1046, the Precedence Rules, if any, have been applied, and the method adds the non-common contacts from the first contact list, i.e., those contacts in the first contact list with no matches in the second contact list, to the new Merged List. Similarly, at step 1048, the method adds the non-common contacts from the second contact list, i.e., those contacts in the second contact list with no matches in the first contact list, to the new Merged List.

In FIG. 14 1280, the merged results for the matched records above are shown. In this merge, the Contact List 1210 was chosen as the primary source for each potentially conflicting field, but in practice, separate precedence orders for each field can be established. For merged record 1285, no conflicts were found. For merged record 1290, the First Name James was selected over Jim, but Jim was added as an Alternate First Name, thus preserving the value. For merged record 1300, Elizabeth was selected as the First Name, Lisa was added as an Alternate First Name, and Office Email of 1@s.c was selected over x@n.m in the Office Email field, even though x@n.m was the value correlated on, and this was stored in the Personal Email field of the merged record.

At step 1050, the new Merged List is stored in the Staging Area. As the Contact Merge method does not impose any limitation on the number of contact lists that can be merged, at step 1060, the process may repeat until all contact lists are merged. In this case, the new contact list is merged with the resulting Merged List from step 1048. For example, with reference to FIG. 2, Contact List A 205, Contact List B 210 and Contact List C 215 may be merged into New Merged Source D 230.

At the end of the merging process at step 1070, the final Merged List may be used as an input feed to the Contact List Refresh method of FIG. 4, to allow the new merged results to refresh existing results from earlier merges, as well as allowing for manual data corrections and augmentations, as described previously. In this way, the final Merged List may be imported as any other imported source.

Locally Added Contacts and Automatic Contact Reconciliation

Even with the ability to merge heterogeneous contact lists, the available input feed contact list may not provide all of the contacts necessary to form the comprehensive list of needed for some applications. It is desirable, then, to provide a means for locally adding contact records to a system.

With further reference to FIG. 3, the Local Overrides store 320 for a contact list may be used to provide this feature. A list administrator may add entirely new records to the Local Overrides store 320. However, these locally added contacts may eventually also show up in input feed contact list, and may lead to potential duplication of records, stale data, and data management problems.

To solve this problem, the Contact List Refresh method treats the Local Overrides 320 differently from the input data feed contact sources. Typically, matching is done only on the primary data seen in the existing and new contact lists. Specifically, the Existing Contact Record 310, rather than the Resultant View 330, is used in step 405 of the Contact Refresh Process of FIG. 4. This is done to maximize the correlation between the data presented in the same input feed over time, and to prevent the manual corrections and additions from interfering with the matching algorithm.

Locally added contacts, however, are loaded into the database staging area in step 405. This allows the locally added contact records to be automatically reconciled with records in the input feed, in effect “removing the appropriate overrides” if a match between a contact in the input feed and a locally added record is found. This step simplifies the process of maintaining a contact list, because it allows an administrator to add contact records as necessary without the additional steps of manually removing the contact record at a later date, or manually reconciling the contact record with a primary input feed.

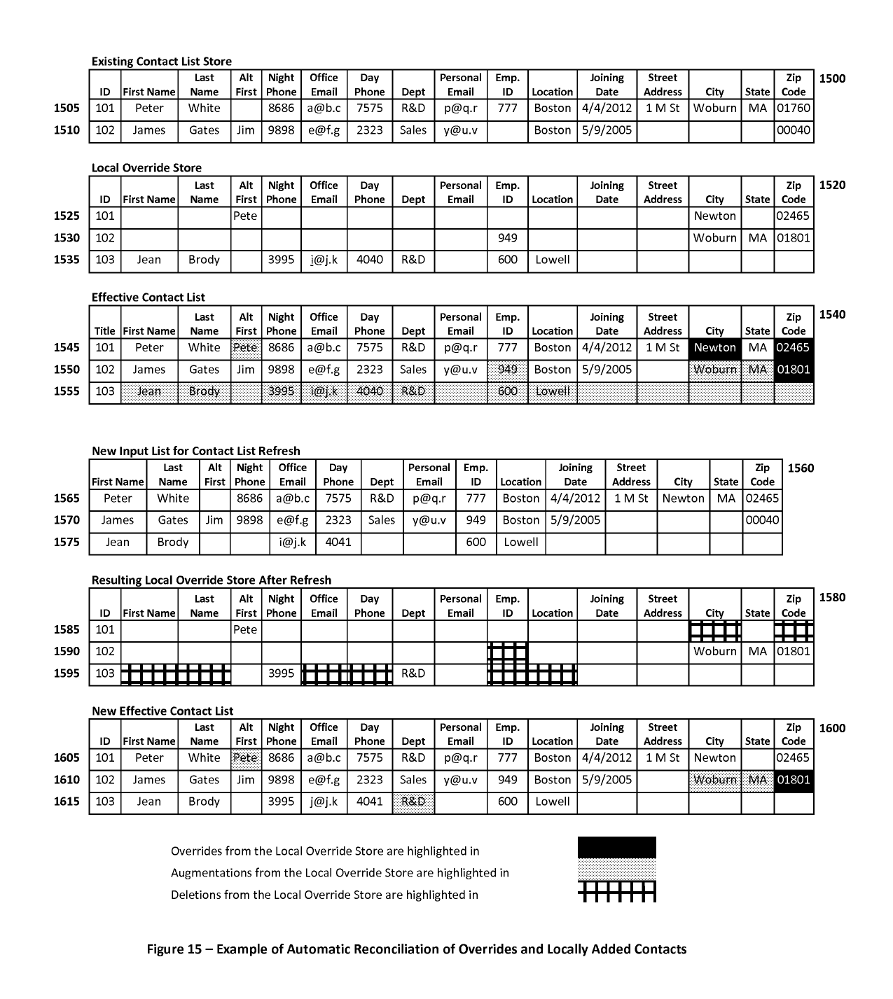

FIG. 15 illustrates this process. There are two records shown in the Existing Contact List Store 1500: (i) record 1505, having a value of 101 in field ID, and (ii) record 1510, having a value of 102 in field ID. In the corresponding Local Override Store 1520, there are two records that provide augmentation and override information for these records in the Existing Contact List Store: (i) record 1525, which provides information for record 1505, sharing the value 101 in field ID, and (ii) record 1530, which provides information for record 1510, sharing the value 102 in field ID. Local Override Store 1520 also contains one locally added contact record 1535, having a value of 103 in field ID.

Combining these two lists, as described above with reference to FIG. 3, produces the Effective Contact List 1540. In this combined list, contact record 1545 has a value of ‘Pete’ in field Alt First, a value of ‘Newton’ in field City, and a value of 02465 in field Zip Code. Contact record 1550 has a value of 949 in field Emp. ID, and a value of 01801 in field Zip Code. Contact record 1555 is shown as “all augmentation,” as it is effectively an augmentation to the contact list itself, rather than to a particular contact in the Existing Contact List Store 1500.

Continuing with the example, if a New Input List 1560 is presented to the Contact List Refresh method, the Local Override Store 1520 will be modified in steps 450 and 455 accordingly, with the results shown in the table Resulting Local Override Store After Refresh 1580. In contact record 1565, the values in the City and Zip Code have now been corrected in the New Input List 1560, and so the overrides to the original data are no longer needed, and so are removed from the Local Override Store (shown in contact record 1585). Similarly, the value in the Emp. ID field of contact record 1570 in New Input List 1560 has now been added to the original contact record, and so this augmented value is also removed from the Local Override Store (shown in contact record 1590). The City and State fields in contact record 1570 are still empty, and the Zip Code value remains the same, and so the augmented City and State values are preserved, and overridden Zip Code value in 1590 remains in the resulting Effective Contact 1610. Finally, a new contact record 1575 has been introduced in the New Input List 1560, and because record contact record 1535 (in Local Override Store 1535) was loaded into the database staging area in step 405 (resulting in contact record 1555 in Effective Contact List 1540), contact record 1575 has been matched with the locally added contact 1535 in Local Override Store 1520.

As a result, the values now present in the resulting Contact Record 1575 are removed from the corresponding contact record 1535 in Local Override Store 1520, to produce the result shown in contact record 1595 in Resulting Local Override Store 1580. (Note here that because the new contact record 1575 has a different value for Day Phone than the locally added contact record 1535, the value in the Local Override Store 1520 is also dropped, in favor of the new value.) After executing the Contact List Refresh method described above, the result is the new Effective Contact List 1600.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A method of correlating a first set of contact records having a first set of fields with a second set of contact records having a second set of fields, the method comprising the steps of:
identifying up to N pairs of semantically-identical fields, where one member of each pair is selected from the first set of contact record fields and the other member of each pair is selected from the second set of contact record fields;
associating at least one of the semantically-identical fields with a correlation weight, where the correlation weight represents the non-uniqueness of any given value in that field;
determining if there are fewer than N pairs of semantically-identical fields;
if there are fewer than N pairs of semantically-identical fields, identifying zero, one or more pairs of semantically-similar fields, where one member of each pair is selected from the first set of contact records and the other member of each pair is selected from the second set of contact records, such that the sum of the pairs of semantically-identical fields and the pairs of semantically-similar fields is less than or equal to N;
associating at least one of the semantically-similar fields, if any, with a correlation weight, where the correlation weight represents the non-uniqueness of any given value in that field;
identifying up to 2^{N} possible combinations of semantically-identical fields and semantically-similar fields, if any;
associating at least one of the possible combinations with a confidence score, where the confidence score is based on the correlation weights of the semantically-identical fields and the semantically-similar fields, if any, in that combination;
identifying one or more matching rules, where each matching rule is one of the possible combinations of semantically-identical fields and semantically-similar fields, if any, and where the confidence score of each of the matching rules represents an acceptable level of non-uniqueness of any given set of values in that combination of semantically-identical fields and semantically-similar fields, if any; and
applying one or more of the matching rules to identify a set of correlated contact records, where each matching rule is applied by selecting pairs of contact records from the first and second sets of contact records where the values match on all of the semantically-identical fields and semantically-similar fields, if any, in that matching rule.

2. The method of claim 1, where at least one of the correlation weights is based on a statistical analysis of values in at least one of the contact record fields.

3. The method of claim 1, where the confidence score for at least one of the combinations is based on the product of the correlation weights of the semantically-identical fields and semantically-similar fields, if any, in that combination.

4. The method of claim 1, where the matching rules are identified only after the possible combinations are associated with a confidence score.

5. The method of claim 1, where the matching rules are applied only after the matching rules are identified.

6. The method of claim 1, where the matching rules are ordered based on their respective confidence scores, and the set of correlated contact records are identified by iteratively applying the matching rules in order.

7. The method of claim 6, where the set of correlated contact records identified in each iteration is removed from the sets of contact records to be considered in the next iteration.

8. The method of claim 1, further comprising the step of:
for each pair of contact records in the set of correlated contact records, updating the value in the first contact record in the pair with the value from the second contact record in the pair.

9. The method of claim 1, further comprising the steps of:
identifying those contact records in the first contact set that have no match to a contact record in the second contact set; and
identifying those contact records in the second contact set that have no match to a contact record in the first contact set.

10. The method of claim 1, further comprising the step of:
merging the pairs of correlated contact records into a third set of contact records by applying one or more precedence rules, where the precedence rules are defined to resolve field conflict resolutions between the first and second sets of contact records.

11. The method of claim 10, where the preference rules are applied in order, and the order is based on the reliability of the data in the first and second contact record sets.

12. A method of identifying a set of correlated contact records from a first set of contact records having a first set of fields and a second set of contact records having a second set of fields, the method comprising the steps of:
identifying up to N pairs of semantically-identical fields, where one member of each pair is selected from the first set of contact record fields and the other member of each pair is selected from the second set of contact record fields;
for at least one pair of the semantically-identical fields, calculating a value that models the likelihood that a record in the first set of contact records matches a record in the second set of contact records, given a match of values in the pair of semantically-identical fields;
determining if there are fewer than N pairs of semantically-identical fields;
if there are fewer than N pairs of semantically-identical fields, identifying zero, one or more pairs of semantically-similar fields, where one member of each pair is selected from the first set of contact record fields and the other member of the each pair is selected from the second set of contact record fields, such that the sum of the pairs of semantically-identical fields and the pairs of semantically-similar fields is less than or equal to N;
for at least one pair of the semantically-similar fields, if any, calculating a value that models the likelihood that a record in the first set of contact records matches a record in the second set of contact records, given a match of values in the pair of semantically-identical fields;
identifying up to 2^{N} possible combinations of semantically-identical fields and semantically-similar fields, if any;
for at least one of the possible combinations, calculating a product of the calculated values for the semantically-identical fields and the semantically-similar fields, if any, in that combination;
ranking the set of possible combinations by their respective calculated product probabilities;
selecting a threshold record match probability;
identifying one or more matching rules, where each matching rule is one of the possible combinations of semantically-identical fields and semantically-similar fields, if any, and where the calculated product probability is greater than or equal to the threshold record match probability; and
iteratively applying one or more of the matching rules in the order of highest to lowest record match probability, to identify a correlated set of contact records, where each matching rule is applied by selecting pairs of contact records from the first and second sets of contact records where the values match on all of the semantically-identical fields and semantically-similar fields, if any, in that matching rule.

13. The method of claim 12, where the matching rules are identified only after all the record match probabilities are calculated.

14. The method of claim 12, where the matching rules are applied only after all of the matching rules are identified.

15. The method of claim 12, where the set of correlated contact records identified in each iteration is removed from the sets of contact records to be considered in the next iteration.

16. The method of claim 12, further comprising the steps of:
for each pair of contact records in the set of correlated contact records, updating the value in the first contact record in the pair with the value from the second contact record in the pair;
identifying those contact records in the first contact set that have no match to a contact record in the second contact set; and
identifying those contact records in the second contact set that have no match to a contact record in the first contact set.

17. The method of claim 12, further comprising the step of:
merging the pairs of correlated contact records into a third set of contact records by applying one or more precedence rules in order, where the precedence rules are defined to resolve field conflict resolutions between the first and second set of contact records.

18. The method of claim 17, where the precedence rules further define whether conflicting data that is not included in the third contact set is discarded or preserved.

19. The method of claim 12, further comprising the step of:
associating an augmentation data set with the first set of contact records, such that values in the data set can augment values in the records of the first set of contact records.

20. The method of claim 12, further comprising the step of:
associating an augmentation data set with the first set of contact records, such that any augmentation value is preserved until the underlying data in a matched contact record is changed.

21. A method of identifying a set of correlated contact records from a first set of contact records having a first set of fields and a second set of contact records having a second set of fields, the method comprising the steps of:
identifying up to N pairs of matching fields, where one member of each pair is selected from the first set of contact record fields and the other member of each pair is selected from the second set of contact record fields;
calculating a field correlation weight for at least one of the matching fields, where the field correlation weight represents the probability that a matching value in this field indicates a match between two contact records having a matching value in this same field;
identifying up to 2^{N} possible combinations of the matching fields;
after all the field correlation weights are calculated, calculating a record match probability for at least one of the possible combinations as the product of the field correlation weights calculated for the matching fields in that combination;
after all the record match probabilities are calculated, ranking the set of possible combinations by their respective record match probabilities;
selecting a threshold record match probability;
after all of the possible combinations are ranked, identifying one or more matching rules, where each matching rule is one of the possible combinations of matching fields, and where the record match probability is greater than or equal to the threshold record match probability;
after all of the matching rules are identified, iteratively applying one or more of the matching rules in the order of highest to lowest record match probability, to identify a set of correlated set of contact records, where each matching rule is applied by selecting pairs of contact records from the first and second sets of contact records where the values match on all of the matching fields in that matching rule; and
removing the sets of contact records identified in each iteration from the sets of contact records to be considered in the next iteration.
